(19) United States
(12) Patent Application Publication
(10) Pub. No.: US 2003/0030840 A1
(43) Pub. Date: Feb. 13, 2003

(54) Direct printing from internet database

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/925,650

(22) Filed: Aug. 10, 2001

(51) Int. Cl. B41J 1/00; G06F 15/00; H04N 1/46

(52) U.S. Cl. 358/1.15; 358/502

(57) ABSTRACT

A printing method, comprising the steps of: receiving data at a printer; determining whether a URL or external network option is enabled; detecting if a network address in the received data; sending on the Internet or other network an access request for a document to the network address; retrieving the document from the network address; and printing the document.

### FIELD OF THE INVENTION

The present invention relates generally to the field of printers, fax machines, and copiers, and more particularly, to such devices which access documents either directly or indirectly from the internet.

### SUMMARY OF THE INVENTION

Briefly, the present invention comprises, in one embodiment, a printing method, comprising the steps of: receiving data at a printer; determining whether a URL or external network option is enabled; detecting if a network address is present in the received data; sending on the Internet or other network an access request for a document to the network address; retrieving the document from the network address; and printing the document.

In a further aspect of the present invention, the external network address is a URL.

In a further aspect of the present invention, the detecting a network address step comprises detecting a barcode in the received data and translating the barcode to the network address.

In a further aspect of the present invention, if the URL or other external access option is not enabled, then printing the untranslated barcode.

In a further aspect of the present invention, the step is included of enabling/disabling the URL or external network access option.

In a further aspect of the present invention, the step is included of presenting a display to a user or control entity to enable/disable the URL or external network access option.

In a further aspect of the present invention, the display is provided from a printer driver.

In a further aspect of the present invention, the step is included of enabling/disabling the URL or external network access option from a control panel.

In a further aspect of the present invention, the control panel is at the printer.

In a further aspect of the present invention, the control panel is at a remote administrator location.

In a further aspect of the present invention, the step is included of sending of a user name or password to the remote administrator location.

In a further aspect of the present invention, the step is included of automatically enabling/disabling the URL or external network access option based on a criteria.

In a further aspect of the present invention, the criteria is whether the URL or external network device meets a security requirement.

In a further aspect of the present invention, the security requirement is the receipt of an authorized user name and/or password.

In a further aspect of the present invention, the receiving data step comprises receiving an e-mail containing the data.

In a further aspect of the present invention, the receiving data step comprises receiving an e-mail with an attachment containing the data.

In a further aspect of the present invention, the translating step comprises translating the barcode to obtain a PIN#; and wherein the sending step includes sending the PIN# with the access request to the external network address for determining if the request is authorized.

In a further aspect of the present invention, the detecting a network address step comprises interpreting a wrapper indicating that the wrapped data is a barcode.

In a further aspect of the present invention, the translated bar code includes information on printing the document inside another document; and further comprising the step of printing the document inside the other document in accordance with the printing information upon receipt of the document at the printer.

In a further aspect of the present invention, the step is included of printing the document inside a master document.

In a further aspect of the present invention, the detecting of a network address step further comprises obtaining at least one identifier that designates the type of contents in the document; and determining a location of the document within the master document based on the identifier.

In a further embodiment of the present invention, a program product is provided including machine readable program code for causing a machine to carry out the following method steps: receiving data at a printer; determining whether a URL or external network option is enabled; detecting if a network address in the received data; sending on the Internet or other network an access request for a document to the network address; retrieving the document from the network address; and printing the document.

In a further aspect of the present invention, the program code for performing the detecting a network address step comprises program code for detecting a barcode in the received data and translating the barcode to the network address.

In a further aspect of the present invention, program code is provided for performing the step of enabling/disabling the URL or external network access option.

### BRIEF DESCRIPTION OF THE DRAWINGS

FIG. 1 is a schematic block diagram of an overall system which may be utilized to implement the present invention.

FIGS. 2a and 2b comprise a block diagram flow chart of the method steps and computer program which may be utilized to implement a preferred embodiment of the present invention.

FIG. 3 is a block diagram flow chart providing further details of block 200 in FIG. 2.

### DETAILED DESCRIPTION OF THE PREFERRED EMBODIMENTS

A preferred embodiment of the present invention is implemented utilizing a printer 10. One skilled in the art will recognize that the implementation to be described may also be applied to a facsimile machine or a copier machine. In one embodiment of the implementation of the present invention, the device 10 may include a processor 20, a memory 30, device specific hardware and a user interface 40, and input/output circuitry 50. The processor 20 performs device specific functions for the device 10 in combination with the device specific hardware 40. In the embodiment where the device 10 is a printer, the processor 20 and the memory 30 perform image rendering functions and the device specific hardware 40 includes printer hardware and associated circuitry. The input/output circuitry 50 for such a printer provides network access to the printer device 10. It is preferred that the device specific hardware and user interface 40 include a display screen for providing information and selection options to a user, as well as various buttons and other controls for the user to make selections.

In a preferred embodiment of the present invention, web server functionality is embedded in the printer device 10 by providing software or firmware for the processor 20, by utilizing space available in the memory 30 and by using the existing input/output circuitry 50 such as Ethernet circuitry to transfer HTML files. Implementations of such web access software are widely available in the art. This web access software on the processor 20 would operate to access a URL (Universal Resource Locator) or other external network address at a remote device 70 by means of the internet 60 or other external network. The purpose for this access to the URL at the device 70, which will be explained in more detail below, is to retrieve a document thereat for printing/copying/faxing at the device 10 or another device selected by the user.

In an alternative embodiment, the web server functionality need not be included in the device 10. Rather the input/output circuitry 50 can be connected to a communications network to thereby connect to an internet access device (not shown) for accessing a URL 70 or other external network address via the internet 60. By way of example, this communications network could be a wide area network (WAN), an internetwork, a public telephone network or a private value added network (VAN). Alternatively, the communications network could be implemented using any combination of these different kinds of communications networks. A desired URL would be sent to this internet access device on the communications network to thereby access the web and a document on the URL 70.

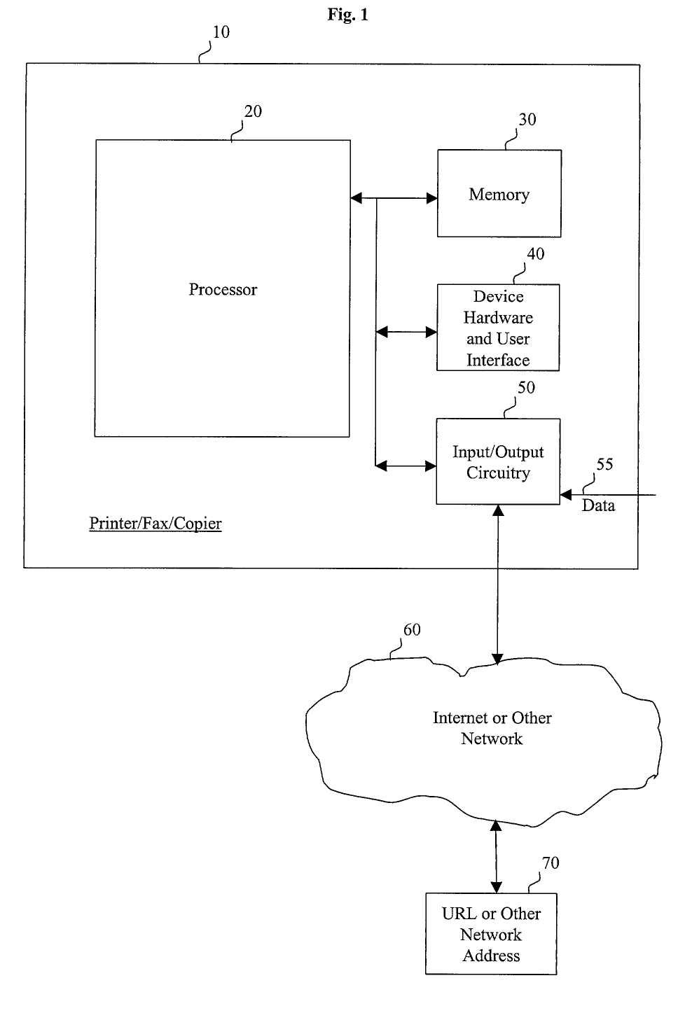

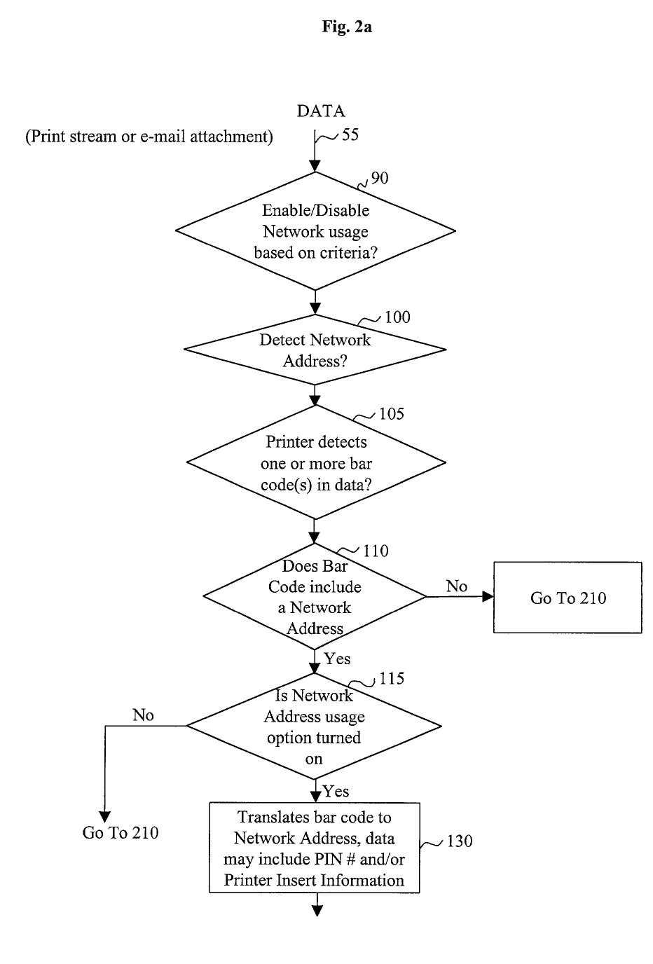

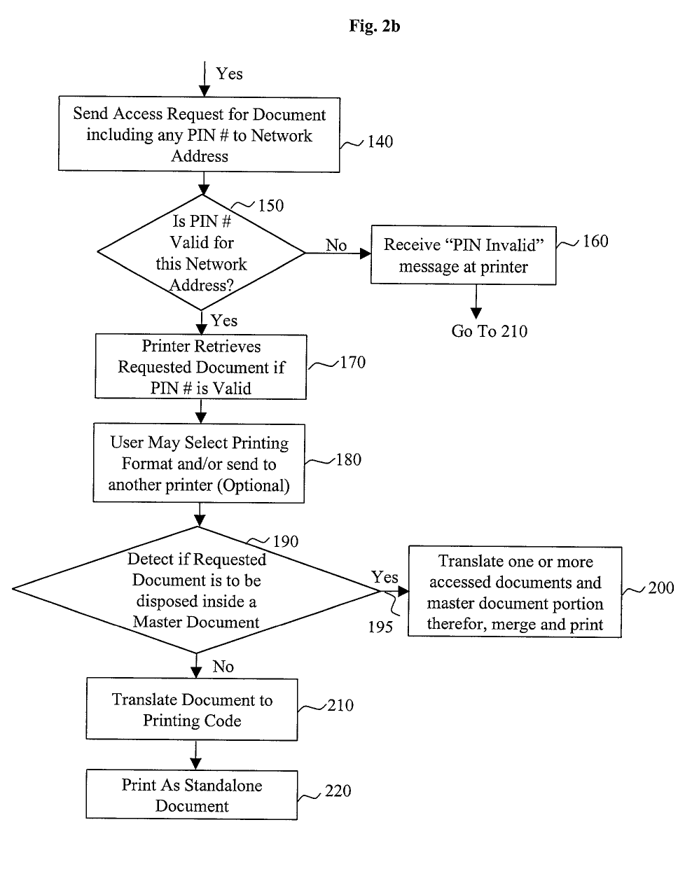

Referring now to FIG. 2, a preferred embodiment of the method and system and program product of the present invention which may be implemented using the structure of FIG. 1 is shown.

As a first step of the method, data is applied on line 55 to the input/output circuitry 50 of the device 10. This is represented in FIG. 2 by the line 55. By way of example, this data could be a print stream. Alternatively, this data could comprise an email, or an attachment to an email, or data that is scanned into the printer system.

As a first step of the method, an external network access option may be enabled/disabled. This operation is represented by block 90. There are a variety of different methods available to accomplish this enablement/disablement either by a user, or by a remote administrator that could permanently or temporarily enable/disable the remote access functionality. By way of example, this step could be performed by receiving an indication by a user from a control button or other control designator on a printer control panel, or by receiving an indication from a control panel at the location of the remote administrator or other person. Alternatively, the step could be performed by the user or a remote administrator clicking a display button or otherwise indicating a selection on a graphical user interface, either presented to the user at the printer location or other user location, or presented to the remote administrator at the remote administrator location. If a display method is used, then a printer driver could automatically present the display to the user or the remote administrator when the printer, or a selected function of the printer is activated. As noted, display presentation could be provided at the user site, e.g., either the printer site itself, or a remote site where the user activated the printer, or at the remote administrator site.

Note that if a remote administrator is used to control this remote access option, then the user could be required to input its user name and/or password or other credential, which could then be compared by the remote administrator or compared automatically to one or a set of authorized user names or passwords.

Alternatively, the step of enabling/disabling the remote access option could be performed automatically based on one or more predetermined criteria. By way of example but not by way of limitation, the criteria could be whether or not the URL or other external network location of the site meets a security requirement. This security requirement could be the receipt of an authorized user name and/or password. Alternatively, this security requirement could comprise whether or not the printer is behind a firewall or otherwise has antivirus protection, e.g., includes or is on a network that has antivirus software.

The next step in the execution, represented by block 100, is for the printer or other device 10 to detect one or more encrypted or non-encrypted network addresses in the data on line 55. By way of example but not be way of limitation, this detection could be accomplished by detecting delimiters at the front and the end of the external network address. Such delimiters could comprise UML tags or PJL commands. In a preferred embodiment, the network address could be a URL or other reference. Additionally, the execution could also detect a pin # and/or a location identifier or a document type identifier to be discussed in more detail below. Such pin # and/or location identifier or document type could be detected in any convenient manner, including through the use of delimiters. In one embodiment, if a network address is detected, then the execution could jump directly to block 115, to be discussed below.

If no network address is detected, or in some embodiments even when a network address is detected, the execution would proceed to block 105 to determine if a barcode is present in the data stream. By way of example, but not by way of limitation, the barcode could be detected by interpreting a wrapper or delimiter that indicates that the wrapped data is a barcode. In one implementation of this embodiment, the block 105 could comprise the printer detecting one or more barcodes in the data stream.

If no URL or other embedded reference is detected in the barcode, then the execution moves to block 210 and the barcode is printed as regular data. If the printer processor 20 detects at least one barcode in the data, then the execution moves to block 110, wherein it is determined whether the barcode includes a URL or other network address reference.

It should be noted that the term URL is used as one example of an implementation of the present invention, and it is understood that the present invention is not limited to only the use of URLs, but may be used to detect and use any convenient network address.

The execution then proceeds to block 115, wherein it is determined if the external network option of block 90 has been enabled/disabled. If the external network option has not been enabled, then no access to the external network is performed and the execution proceeds to block 180 or 210, to be discussed below, wherein the data is translated into printing code. Alternatively, if the external network option has been enabled, then the execution proceeds to block 130.

Block 130 translates the barcode to a URL or other reference. In one embodiment, the barcode may additionally include a PIN number which may be used to verify authorization to access the remote URL or other reference. Additionally, the barcode may also include printer insert information if the document to be retrieved from the network address is to be inserted inside a master document. This printer insert information may include, by way of example but not by way of limitation, coordinates within a portion of the master document, such as a page, at which the network document is to be inserted, or other information such as a document type which may be utilized in accordance with a rule to determine where to insert the network document within the master document. For example, a map document at the network address may be designated with the document type “MAP”, and inserted to a location in the master document labeled “MAP”.

The execution then moves to block 140. In block 140 an access request is generated and sent on the internet 60 to retrieve the document at this network address. As noted above, this access request may include a PIN number.

In block 150 it is determined whether a PIN number, if one is present, is valid for this URL or other network address. If the PIN number is not valid, then the message “PIN Invalid” or other convenient message is received at the printer, per block 160. In a preferred embodiment, the printer or another device could then generate and send a message, which could include the network address, alerting the user or other person that an invalid pin # has been received. Then the execution moves to block 210 and the bar code or network address is printed as regular data in the print stream with the other data being printed.

Alternatively, if the PIN number is determined to be valid for the access to the URL or other network address, then the execution moves to block 170, and the printer retrieves the requested document. Optionally, the execution may then move to block 180 wherein the device hardware and user interface 40 displays printing format selection options to a user. Additionally, or alternatively, the option to send this retrieved document to another printer may be provided. For this optional execution block, the user would be given the opportunity by means of various buttons and other appropriate controls to make a selection of the printing format and/or transmission of the document to another printer or other appropriate device. Note that this optional execution block 180 could be located anywhere within the process.

The execution then moves to block 190 wherein it is detected if the requested document is to be disposed inside a master document. If the answer is NO, then the execution moves to block 210 and the retrieved URL document is translated to printing code. Note that the retrieved URL document will include format information for the layout of the document. The execution then moves to block 220 wherein the translated document is printed on the device hardware 40 under the control of the processor 20. The process could then loop back to block 100 and look for additional network addresses and barcodes to process.

Alternatively, if it is determined that the retrieved URL document is to be disposed inside a master document, then the execution moves to block 200. In block 200, one or more retrieved URL documents and a master document portion or the master document in its entirety are translated into a predetermined format, merged and printed.

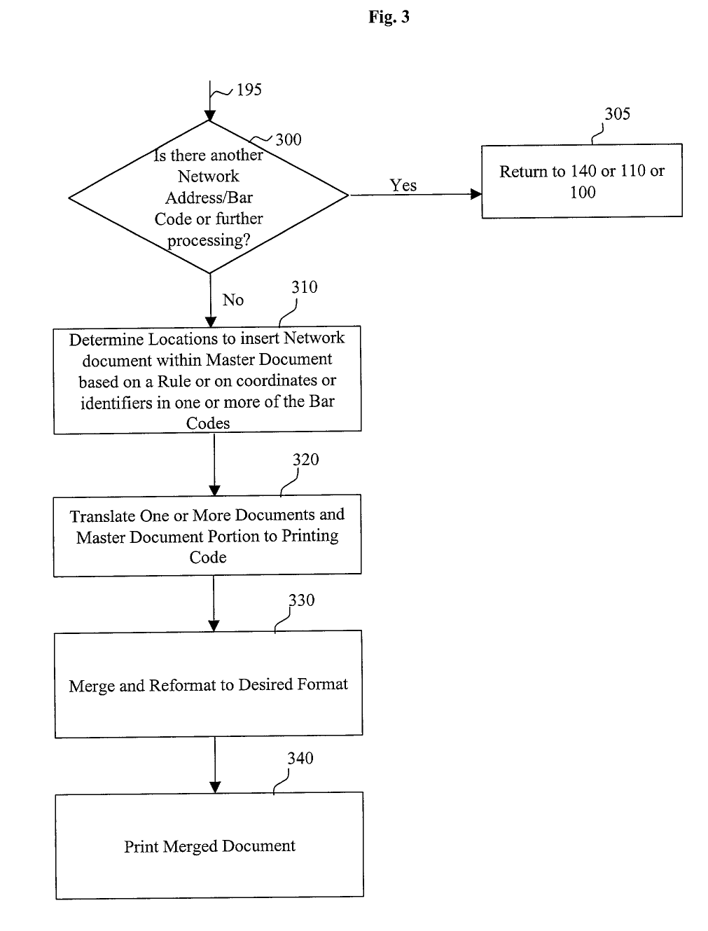

Referring now to FIG. 3, additional method and operational details are provided for the execution block 200. Referring to FIG. 3, the retrieved URL document is applied on line 195 to block 300.

In execution of block 300, it is determined whether there is an additional network address or bar code to process. If the entire data stream for the master document or a portion thereof has been already reviewed and all of the network addresses detected or barcodes detected, and if the additional item is a network address, then in block 305 the execution would proceed to block 140 in FIG. 2 and continue the process. Alternatively, if the additional item is a barcode, then the execution proceeds to block 110 and continues the process. Alternatively, if the system did not initially detect all of the network addresses or barcodes on the data stream, then the execution would proceed to 100 and continue the process. Accordingly, additional documents may be retrieved at other network addresses. Multiple different documents at a variety of different remote network addresses may be retrieved in this manner and returned to the device 10. When all of the network addresses and/or barcodes on the master document portion that is to be printed have been translated and the network addresses accessed and the network documents retrieved, then the execution moves to block 310.

It should be noted that depending on the printing software utilized, it may be desirable to perform this process on a page by page basis, or more generally, a portion by portion basis, for the master document. Accordingly, all of the network addresses and barcodes on a particular page that is to be printed are accessed so that those network documents can be merged into that particular master document page. That document page would then be printed, and the printer would then move on to the next page in the master document and search for network addresses and barcodes in the printing data therefore. Alternatively, the printing software may detect all of the network addresses and barcodes in the entire master document and retrieve the documents at various remote network addresses to allow the translation and merger of those network documents with the master documents in one operation. Whether the software utilized operates on a portion by portion basis or retrieves all of the network addresses for the entire master document at one time is a design choice within the skill of the art.

If there are no more network addresses or barcodes to be translated and network documents to be accessed for the portion of the master document to be printed, then the execution moves to block 310 wherein it is determined in which location or locations to insert the network documents within the master document. The locations for insertion of the various retrieved network documents within the master document may be based on coordinates included within each of the network addresses or different barcodes. Alternatively, the locations may be determined in accordance with a rule. By way of example but not by way of limitation, the rule could comprise simply inserting into a set of blocks within the master document the network documents in the order in which the network addresses or barcodes were detected. Alternatively, this rule could comprise using an identifier or tag translated from each of the different network addresses or barcodes to insert the respective document associated with that barcode to a space which is identified by the respective identifier within that document. By way of example, an identifier could identify the document type to be an “EXECUTIVE SUMMARY”, and there could be an insert box within the master document which includes an identifier “EXECUTIVE SUMMARY” that matches the identifier.

The execution then moves to block 320 wherein the one or more network documents and the master document portion are translated to printing codes.

The execution then moves to block 330 wherein the one or more network documents and the master document portion are merged and reformatted to a desired format. By way of example but not by way of limitation, a typical format for printing would be PCL or Postscript. The execution then moves to block 340 wherein the merged document portion or the entire document is printed by the device hardware 40.

Note that there may be situations wherein web access capability is not available at the device 10. In this situation where there is no web access capability within the device 10, then after the network address is obtained directly or obtained after translation from a barcode, then the execution moves to a block wherein a search query is sent out on a communications network via the input/output circuitry 50 (FIG. 1) to connect to an internet access device for accessing the web. By way of example, this communications network could simply comprise an intranet and the access could be to a web access software module or to a web server on the intranet. This internet access device would then be utilized to access the network address by means of the internet 60. If the PIN number, if any, is determined to be valid by this URL 70, then the requested document is retrieved back to the internet device, and from that device it is provided to the printer device 10 for printing as described previously for FIG. 2.

It should be noted that the present invention is particularly advantageous for summary reports, wherein various sections of the report are being continuously updated. The present invention, by means of the insertion of one or more network addresses or barcodes within a master document, allows a report to be updated on the fly by accessing a plurality of different URL's or other network addresses which are maintained with up-to-date information. In one aspect, a company could maintain a variety of its documents on the internet but accessible only by means of a PIN number or some other security operation. This invention would allow access to such documents without the need for firewalls. Additionally, the present invention is particularly advantageous in that it provides an accurate rendition of a URL or other network address, via the direct detection of a network address or via a translation of a barcode, without the need for human intervention with the potential for typographical errors. Accordingly, an error free transmission of a document to a printer or other device such as a fax machine or copier, can be accomplished simply by sending an email with one or more barcodes embedded therein.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A printing method, comprising the steps of:
receiving data at a printer;
determining whether a URL or external network option is enabled;
detecting if a network address in the received data;
sending on the Internet or other network an access request for a document to the network address;
retrieving the document from the network address; and
printing the document.

2. The method as defined in claim 1, wherein the external network address is a URL.

3. The method as defined in claim 1, wherein the detecting a network address step comprises detecting a barcode in the received data and translating the barcode to the network address.

4. The method as defined in claim 3, wherein, if the URL or other external access option is not enabled, then printing the untranslated barcode.

5. The method as defined in claim 1, further comprising the step of enabling/disabling the URL or external network access option.

6. The method as defined in claim 1, further comprising the step of presenting a display to a user or control entity to enable/disable the URL or external network access option.

7. The method as defined in claim 6, wherein the display is provided from a printer driver.

8. The method as defined in claim 1, further comprising the step of enabling/disabling the URL or external network access option from a control panel.

9. The method as defined in claim 8, wherein the control panel is at the printer.

10. The method as defined in claim 8, wherein the control panel is at a remote administrator location.

11. The method as defined in claim 10, further comprising the step of sending of a user name or password to the remote administrator location.

12. The method as defined in claim 1, further comprising the step of automatically enabling/disabling the URL or external network access option based on a criteria.

13. The method as defined in claim 12, wherein the criteria is whether the URL or external network device meets a security requirement.

14. The method as defined in claim 13, wherein the security requirement is the receipt of an authorized user name and/or password.

15. The method as defined in claim 1, wherein said receiving data step comprises receiving an e-mail containing said data.

16. The method as defined in claim 1, wherein said receiving data step comprises receiving an e-mail with an attachment containing said data.

17. The method as defined in claim 3, wherein said translating step
comprises translating the barcode to obtain a PIN#; and
wherein said sending step includes sending the PIN# with the access request to the external network address for determining if the request is authorized.

18. The method as defined in claim 1, wherein the detecting a network address step comprises interpreting a wrapper indicating that the wrapped data is a barcode.

19. The method as defined in claim 3, wherein the translated barcode includes
information on printing the document inside another document; and
further comprising the step of printing the document inside the other document in accordance with the printing information upon receipt of the document at the printer.

20. The method as defined in claim 1, further comprising the step of printing the document inside a master document.

21. The method as defined in claim 20, wherein the detecting of a network address step further comprises
obtaining at least one identifier that designates the type of contents in said document; and
determining a location of the document within the master document based on said identifier.

22. A program product including machine readable program code for causing a machine to carry out the following method steps:
receiving data at a printer;
determining whether a URL or external network option is enabled;
detecting if a network address in the received data;
sending on the Internet or other network an access request for a document to the network address;
retrieving the document from the network address; and
printing the document.

23. The program product as defined in claim 22, wherein program code for performing the detecting a network address step comprises program code for detecting a barcode in the received data and translating the barcode to the network address.

24. The program product as defined in claim 22, further comprising program code for performing the step of enabling/disabling the URL or external network access option.
